(19) United States
(12) Patent Application Publication
(10) Pub. No.: US 2026/0220235 A1
(43) Pub. Date: Jul. 30, 2026

(54) Hybrid Decentralized Identity (BEIDID/DRID) and Assetization Infrastructure with Dual Anchoring, BEISIGN Consent, READ Rollback, Green-Gated Tokenization, Atomic Clearing, and Cross-Industry Instantiation

(71) Applicant: FURONG BEI, San Gabriel, CA (US)

(72) Inventor: Furong BEI, San Gabriel, CA (US)

(21) Appl. No.: 19/315,561

(22) Filed: Aug. 31, 2025

Related U.S. Application Data
(63) Continuation-in-part of application No. 19/073,574, filed on Mar. 7, 2025, now abandoned.
(63) Continuation-in-part of application No. 19/094,730, filed on Mar. 28, 2025.
(63) Continuation-in-part of application No. 19/084,806, filed on Mar. 20, 2025.
(63) Continuation-in-part of application No. 19/079,378, filed on Mar. 13, 2025.
(63) Continuation-in-part of application No. 19/074,326, filed on Mar. 8, 2025, now abandoned.
(63) Continuation-in-part of application No. 19/056,745, filed on Feb. 19, 2025.
(63) Continuation-in-part of application No. 19/192,322, filed on Apr. 28, 2025.
(63) Continuation-in-part of application No. 19/196,039, filed on May 1, 2025.
(63) Continuation-in-part of application No. 19/204,518, filed on May 10, 2025.
(63) Continuation-in-part of application No. 19/059,110, filed on Feb. 20, 2025, now abandoned.
(63) Continuation-in-part of application No. 19/171,298, filed on Apr. 6, 2025.
(63) Continuation-in-part of application No. 19/067,171, filed on Feb. 28, 2025, now abandoned.
(63) Continuation-in-part of application No. 19/073,042, filed on Mar. 7, 2025.
(63) Continuation-in-part of application No. 19/079,362, filed on Mar. 13, 2025, now abandoned.
(63) Continuation-in-part of application No. 19/201,880, filed on May 7, 2025.
(63) Continuation-in-part of application No. 19/072,905, filed on Mar. 6, 2025.
(63) Continuation-in-part of application No. 19/086,150, filed on Mar. 21, 2025.
(63) Continuation-in-part of application No. 19/173,863, filed on Apr. 9, 2025.
(63) Continuation-in-part of application No. 19/067,936, filed on Mar. 2, 2025.
(63) Continuation-in-part of application No. 19/170,666, filed on Apr. 4, 2025.
(60) Provisional application No. 63/769,143, filed on Mar. 9, 2025.
(60) Provisional application No. 63/772,633, filed on Mar. 16, 2025.

(51) Int. Cl. G06F 21/31; G06F 21/60; G06Q 30/018

(52) U.S. Cl. CPC G06F 21/31; G06F 21/602; G06Q 30/018

(57) ABSTRACT

A hybrid decentralized identity infrastructure is disclosed. Each personal subdomain is dual-anchored to a DID document through DNSSEC proofs and an on-chain registry, ensuring global uniqueness. A BEISIGN consent layer cryptographically couples intent, policies, and minimum-disclosure proofs, while a READ rollback loop enforces two-phase confirmation, timelock, freeze, and deterministic rollback for high-risk changes with human-readable artifacts. Identity-bound behavioral and temporal evidence produce a Behavioral Economics Identity Index (BEI Index) in a BEI Engine, gating non-PoW minting of BEITOKEN, TIMECOIN, and BEINFT when Green Operation Indicators (GOI) and Energy-Normalized Metrics (ENM) meet thresholds. Transactions are submitted as an inseparable triplet—instruction, BEISIGN consent, and proofs—into exchange, clearing, and settlement components (BEIGX/BEICX/BEISX) to achieve atomic DVP/PvP with deterministic rollback on failure. Regulatory charters are compiled as executable code in a Policy Virtual Machine with BeiChart versioned activation. The invention enables privacy-preserving identity across finance, healthcare, education, retail, logistics, government, voting, AI, and IoT.

### CROSS-REFERENCE TO RELATED APPLICATIONS

This application is a Continuation-in-Part (CIP) of U.S. patent application Ser. No. 19/073,574 (filed Mar. 7, 2025) and Ser. No. 19/086,179 (filed Mar. 21, 2025). This application also claims the benefit, under 35 U.S.C. § 119(e), of U.S. Provisional Patent Application No. 63/769,000 (filed Mar. 9, 2025). The entire disclosures of the above applications are incorporated herein by reference.

### FIELD OF THE INVENTION

The invention relates to Behavioral Economics Identity (BEI) and to decentralized identifiers, DNSSEC-secured namespaces, distributed-ledger anchoring, cryptographic consent, rollback-enabled audit, green-gated tokenization, and atomic clearing/settlement for regulated, multi-industry applications. It further relates to identity governance as code (Charter-as-Code), dynamic identity growth, and cross-industry instantiation spanning finance, healthcare, education, retail, logistics, government, voting, AI-assisted compliance, and IoT telemetry.

### BACKGROUND

Conventional identity is static and siloed, difficult to update or revoke, and not executable under compliance constraints. Existing decentralized identity frameworks typically lack: (i) bank-grade rollback with timelock/freeze and deterministic recovery; (ii) executable multi-jurisdictional compliance; and (iii) a sustainable, low-energy assetization model tied to identity-bound behavioral and temporal evidence (BEI), rather than energy-intensive consensus. There is a need for a globally unique, dynamic, compliance-enabled, privacy-preserving, and sustainable identity and assetization infrastructure that directly supports atomic settlement across industries and jurisdictions.

### SUMMARY OF THE INVENTION

The invention provides a hybrid BEIDID identity and assetization stack including:
1. Dual Anchoring: bi-directional binding between a DNSSEC-validated personal subdomain and an on-chain DID registry record, enabling collision-free resolution and tamper-evident continuity.
2. BEISIGN Consent Layer: canonical cryptographic statements binding intent, policy, proofs, prior state, and signatures; supports multi-party co-signature and append-only transparency logging with minimum-disclosure redaction.
3. READ Rollback Loop: two-phase confirmation with timelock, freeze, and deterministic rollback; preserves causal history and emits human-readable rollback artifacts for high-risk changes.
4. BEI Engine: computes a Behavioral Economics Identity Index (BEI Index) from identity-bound behavioral and temporal evidence. Minting of BEITOKEN, TIMECOIN, and BEINFT is permitted only when Green Operation Indicators (GOI) and Energy-Normalized Metrics (ENM) satisfy governance thresholds. No proof-of-work is required.
5. Atomic Clearing Triplet: settlement accepts only an inseparable triplet—Instruction, Consent, Proofs (I, C, P)—verified across exchange (BEIGX), clearing (BEICX), and settlement (BEISX) components to effect Delivery-Versus-Payment (DVP) or Payment-Versus-Payment (PvP) with deterministic rollback on failure or dispute.
6. Charter-as-Code: jurisdictional and organizational charters compiled to bytecode in a Policy Virtual Machine (Policy-VM), governed by BeiChart versioning, activation timelocks, and rollback controls; enforces residency, sanctions, retention, risk scoring, and corridor rules.
7. Branch Instantiation: per-person BEIDID subdomains materialize regulated service branches (banking, healthcare, education, retail, government, logistics) with uniform policy enforcement and auditable controls.
8. Extensions: secure e-voting, identity succession, social anti-bot attestations, AI compliance assistants, and IoT telemetry integrated under the same consent, rollback, and policy execution model.

### BRIEF DESCRIPTION OF THE DRAWINGS

FIG. 1 System overview: namespace, dual anchoring, BEISIGN, READ, BEI Engine, Policy-VM, market rails. FIG. 2 Dual anchoring between DNS TXT (DNSSEC chain) and on-chain registry mapping namehash(S) to record fields. FIG. 3 BEISIGN tuple and READ two-phase flow (prepare/commit) with timelock/freeze/rollback. FIG. 4 BEI Engine pipeline; GOI/ENM gating for BEITOKEN, TIMECOIN, BEINFT. FIG. 5 Atomic clearing triplet across BEIGX/BEICX/BEISX with rollback. FIG. 6 Branch instantiation for banking, healthcare, education, retail, government, logistics. FIG. 7 BEI Index computation and publication via zero-knowledge oracle with differential privacy. FIG. 8 Policy-VM deployment of Charter-as-Code with BISec anchors and BeiChart governance. FIG. 9 GOI/ENM definitions, telemetry inputs, thresholds, evaluation points. FIG. 10 Authority-change flow in READ (timelock, co-signature, freeze, rollback).

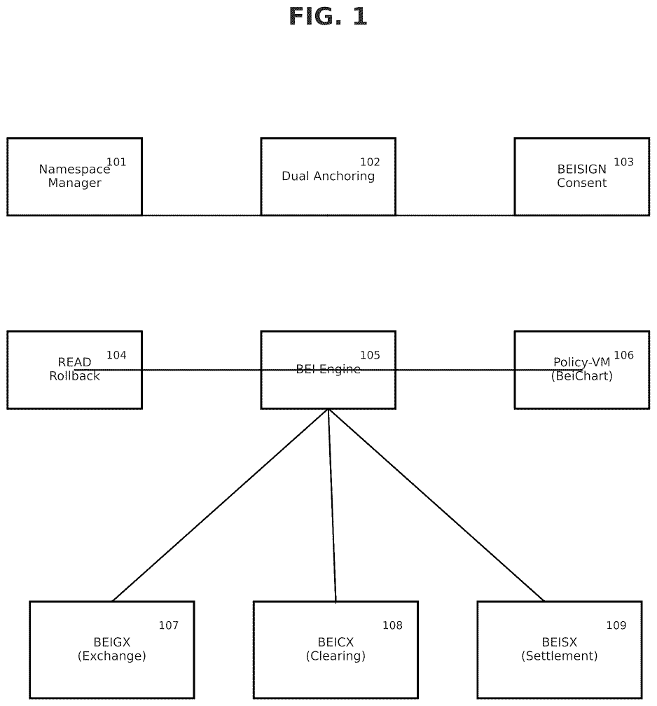

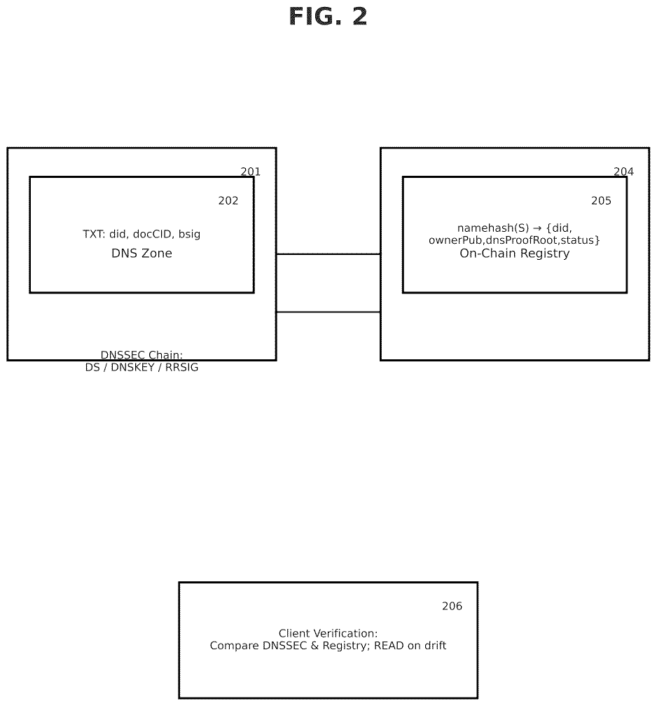

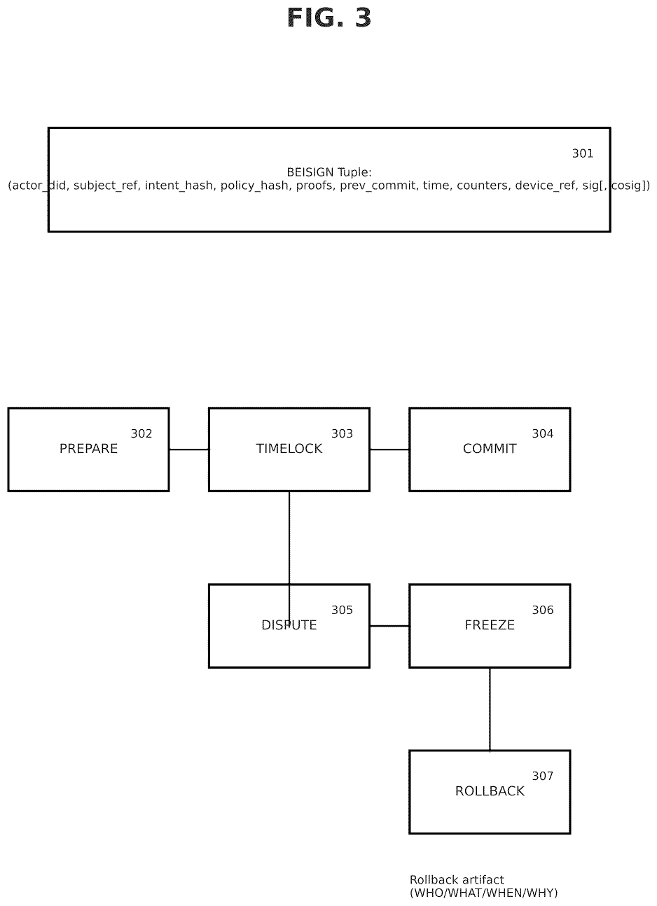

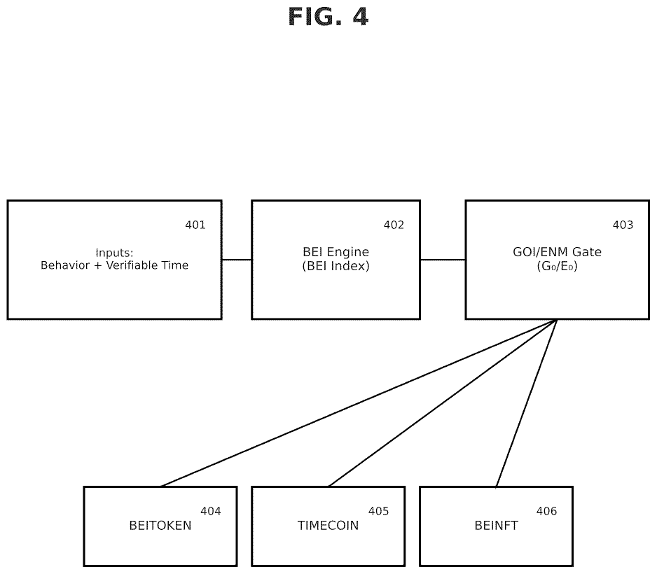

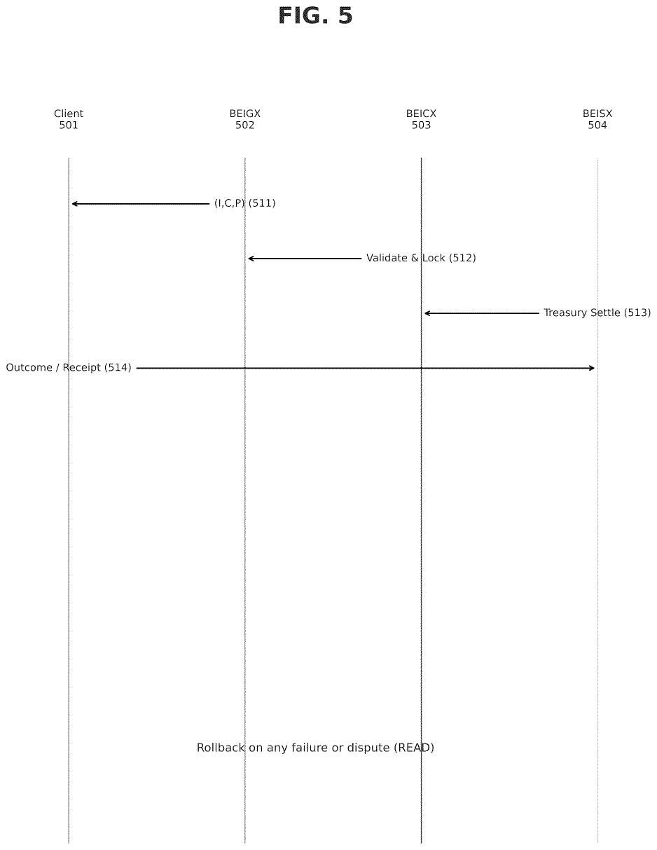

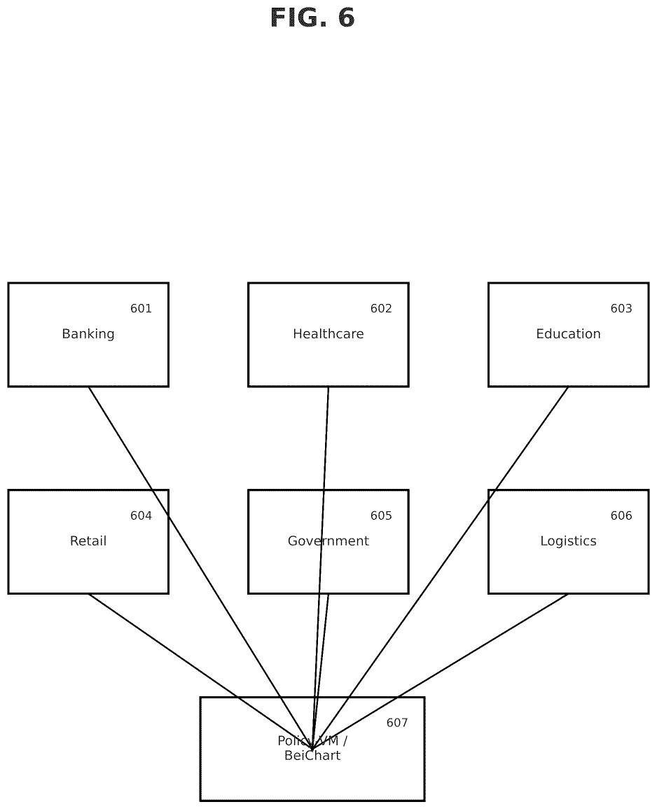

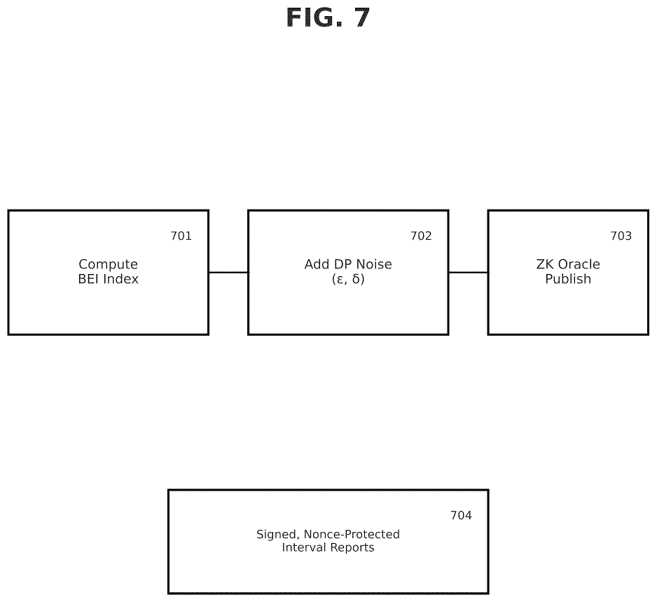

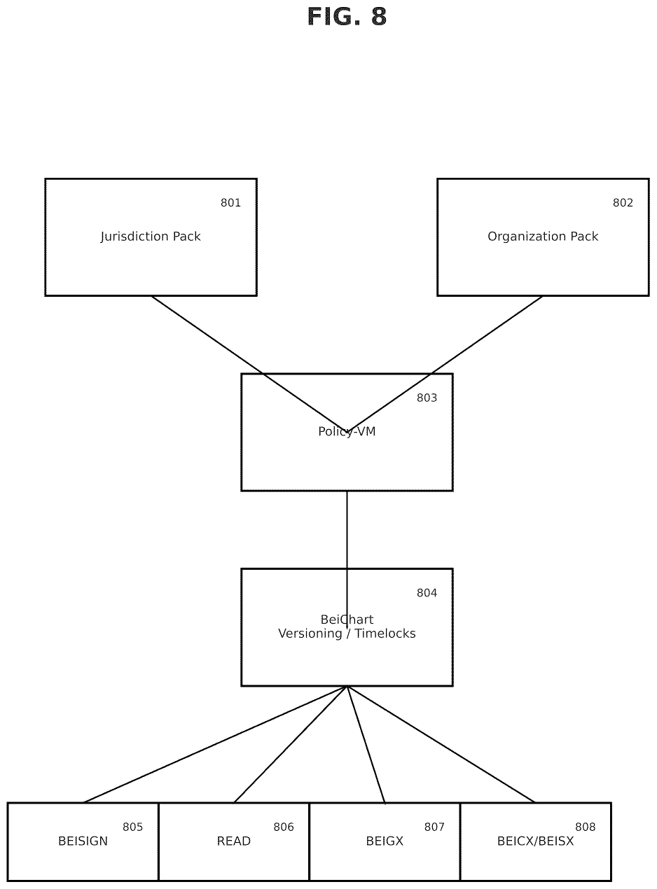

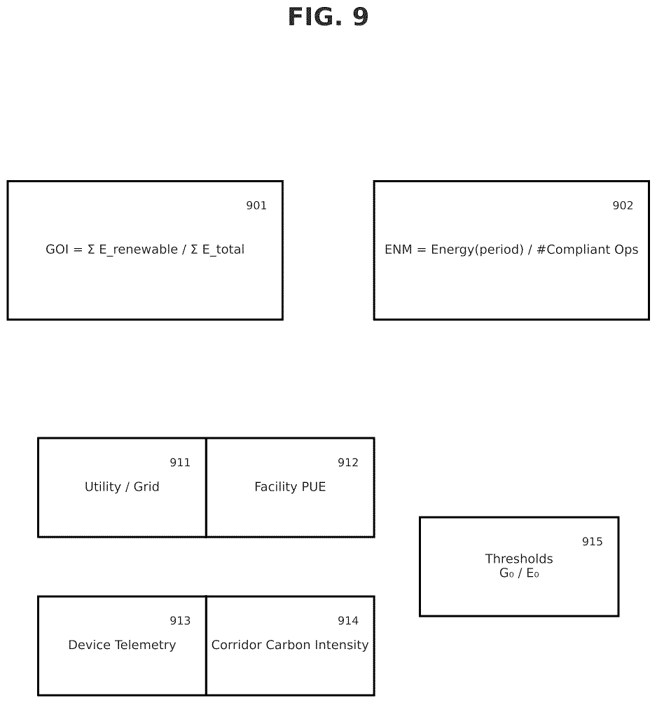

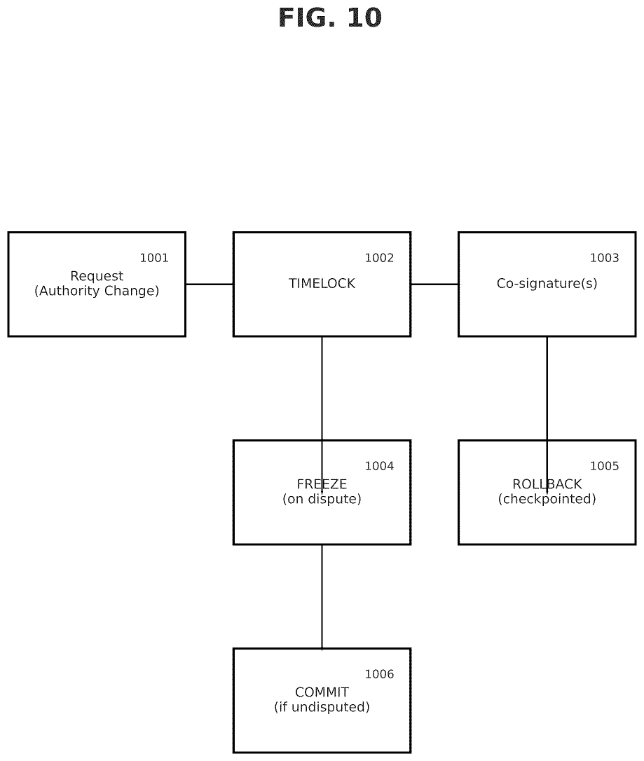

### DETAILED DESCRIPTION OF THE INVENTION

### 1. Definitions

BEIDID/DRID: a decentralized identity bound to a globally unique personal subdomain, emphasizing Behavioral Economics Identity.
Personal Subdomain (S): the string “.” allocated from curated DNSSEC-protected domains.
Dual Anchoring: (i) DNS TXT with DNSSEC chain; and (ii) on-chain registry mapping namehash(S) to {did, ownerPub, dnsProofRoot, status}.
BEISIGN Statement (BSIG): canonical tuple (actor_did, subject_ref, intent_hash, policy_hash, proofs, prev_commit, time, counters, device_ref, sig[, cosig]) encoded using CBOR/COSE or JSON/JWS, hash-linked, and transparency-logged.
READ Loop: control states prepare, timelock, commit, dispute, freeze, rollback.
Triplet (I, C, P): Instruction, BEISIGN consent, and minimum-disclosure proofs.
Policy-VM/BeiChart: runtime and governance for Charter-as-Code with version pinning, activation timelocks, and rollback.
BEI Index: computed index from identity-bound behavioral and temporal evidence used by the BEI Engine to gate tokenization and risk-aware operations.
BEI Engine: pipeline that computes the BEI Index and evaluates GOI/ENM gates for sustainable tokenization and compliant operations.

### 2. BEIDID Core Model (Identity Lifecycle)

### 2.1 Enrollment:

Normalize identifiers (Unicode NFC), apply IDN punycode conversion, and filter for homographs.
Allocate S from curated DNSSEC roots; generate DID document and key material (TEE/threshold optional).
Publish dual anchors: DNS TXT fields did= . . . , docCID= . . . , bsig= . . . with DNSSEC; on-chain registry mapping namehash(S) to the record.

### 2.2 Resolution:

Resolver verifies DNSSEC chain and on-chain mapping; drift or mismatch triggers READ dispute path.
Caches may store succinct proof roots for efficiency.

### 2.3 Update and Authority Change:

All authority-changing intents require BEISIGN with prev_commit continuity, timelock, and (if configured) cosigners; READ enforces two-phase confirmation.

### 2.4 Deactivation and Recovery:

Freeze and rollback paths restore to the last verified checkpoint; social recovery and guardianship policies are supported.

### 3. Namespace and Uniqueness

Anti-phishing allocation rules; blocklisted confusables across language scripts; automated and human review for high-risk patterns.
Portfolio scale: at least 1,999 DNSSEC-governed root domains to deliver capacity, distribution, and policy uniformity.

### 4. Dual Anchoring Mechanism

DNS side: TXT includes did= . . . , docCID= . . . , bsig= . . . , with DNSSEC DS/DNSKEY/RRSIG chain.
Ledger side: namehash(S) maps to {did, ownerPub, dnsProofRoot, status}.
Clients verify both anchors; inconsistencies invoke READ dispute/freeze/rollback.

### 5. Beisign Consent Layer

Deterministic canonicalization (field order, normalized encodings); counters and device_ref mitigate replay.
Multi-party co-signature for high-risk intents; transparency log supports public audit and selective redaction (minimum-disclosure proofs).
prev_commit enforces causal continuity.

### 6. READ Rollback Loop

Reference Pseudocode (ASCII; illustrative and non-limiting)

FUNCTION READ_LOOP(action) STATE=PREPARE IF action.risk>HIGH_RISK_THRESHOLD THEN REQUIRE_TIMELOCK(action.parameters, action.cosigs) AWAIT_TIMELOCK_EXPIRATION END IF IF NO_DISPUTE_TRIGGERED THEN STATE=COMMIT EXECUTE(action) RECORD_CAUSAL_HISTORY(action) ELSE STATE=FREEZE FREEZE_ACCOUNTS(action.involved_dids) CHECKPOINT=DETERMINE_ROLLBACK_POINT(action.causal_history) STATE=ROLLBACK EXECUTE_ROLLBACK(CHECKPOINT) EMIT_ROLLBACK_ARTIFACT(action.summary) END IF END FUNCTION

### 7. Minimum-Disclosure Compliance

Zero-knowledge range and set-membership proofs satisfy KYC, AML, and Travel Rule thresholds without revealing raw attributes.
Residency/retention/sanctions rules compiled to Policy-VM guards; non-conforming operations are rejected.
Offline COSE/CBOR proof bundles support intermittent devices; reconciliation upon connectivity.

### 8. BEI Engine and Green-Gated Minting

Identity-bound behavioral and temporal evidence produce the BEI Index. Minting of BEITOKEN, TIMECOIN, and BEINFT is permitted only when both conditions hold:
GOI>=G0
ENM<=E0

Plain-English formulas (ASCII):
GOI=sum(E_renewable_i)/sum(E_total_i)
ENM=TotalEnergy(period)/CompliantOperations(period)

Anti-gaming controls include rate limits, anomaly detection, cross-source attestation, and revocation hooks. No proof-of-work is required.

### 9. Atomic Clearing and Settlement

Accept only the triplet (I, C, P).
BEIGX (exchange/validation): verify BEISIGN and proofs; forward valid instructions.
BEICX (clearing/netting): lock positions; compute multi-leg netting across corridors.
BEISX (settlement/treasury): execute updates; any failure or dispute freezes and rolls back the entire transaction via READ.
Supports DVP and PvP; dead-letter safety and idempotency keys may be used.

### 10. Charter-as-Code (Policy Execution)

Jurisdiction and organization packs compiled to Policy-VM bytecode anchored by BISec.
BeiChart governs version pinning, activation timelocks, and rollback of policies.
Controls include residency, retention, sanctions, risk scoring, corridor rules, and audit obligations; all bound to consent and settlement messages.

### 11. Branch Instantiation (Industry Templates)

Banking (ATMS): onboarding, account lifecycle, deposits/withdrawals, ACH/SEPA/UPI/wire remittance, ledger adapters.
Healthcare: clinic credentials, consent receipts, BEISIGN-scoped access, READ trails.
Education: verifiable course/exam/certification credentials anchored by dual anchoring.
Retail/Franchise: identity-linked payments, loyalty, READ-based disputes/refunds.
Government: e-government identity, benefits, residency enforcement.
Logistics: provenance, chain-of-custody, customs policies as code.

### 12. Security and Key Management

Keys in TEEs; threshold signatures; social recovery.
Anti-homograph and allocation controls; transparency logs for public audit; compromise/revocation procedures governed by policy.

### 13. Interoperability and Standards

Compatible with W3C DID/VC, IETF DNS/DNSSEC, common ZK proof suites.
Encodings: CBOR/COSE and JSON/JWS with canonicalization for signature stability.
Ledger-agnostic registry with succinct Merkle-proof inclusion.

### 14. Performance and Scalability

Caching DNSSEC proof roots; batch verification; succinct proofs reduce on-chain footprint.
Oracles publish BEI Index intervals with differential privacy and ZK attestation.
Sharding, queues, and checkpointing mitigate peak contention.

### 15. Industrial Applicability

Finance, healthcare, education, retail, logistics, government identity, ESG, voting, AI assistants, and IoT telemetry—enabling compliant identity, sustainable assetization, and atomic clearing at internet scale.

What is claimed is:

1. A hybrid decentralized identity system, comprising: (a) a namespace manager configured to normalize personal identifiers and allocate a personal subdomain from curated DNSSEC-governed roots; (b) a dual-anchoring module configured to bind the personal subdomain to a decentralized identifier (DID) document by publishing both (i) a DNSSEC proof chain for a DNS TXT record and (ii) an on-chain registry record for a same mapping; (c) a consistency monitor configured to verify, for each access or update, that the DNSSEC-anchored record and the on-chain registry record are mutually consistent, and upon detecting a drift or mismatch to automatically invoke a rollback-enabled execution and audit (READ) control loop that freezes affected actors and reverts state to a causal-consistent checkpoint; (d) a BEISIGN consent layer configured to generate canonical tuples comprising an intent hash, a policy hash, minimum-disclosure proofs, a prior commitment reference, time data, counters, a device reference, and one or more cryptographic signatures; (e) a pipeline that enforces an inseparable triplet comprising an instruction, a BEISIGN consent, and proofs across an exchange component (BEIGX), a clearing component (BEICX), and a settlement component (BEISX), wherein each component validates the triplet and fails closed with freeze and rollback on validation failure; (f) a Policy Virtual Machine (Policy-VM) governed by BeiChart versioning and activation timelocks, the Policy-VM applying jurisdictional and organizational rule packs to the consent layer and to each component of the pipeline; and (g) branch instantiation logic enabling regulated service templates in finance, healthcare, education, retail, government, or logistics to operate under the personal subdomain.

2. A method for identity-driven assetization and clearing, comprising: (a) publishing, for a personal subdomain, both a DNSSEC-anchored TXT record and an on-chain registry record that together bind the subdomain to a DID document; (b) encoding identity-bound behavioral and temporal evidence into a Behavioral Economics Identity Index (BEI Index); (c) admitting minting of BEITOKEN, TIMECOIN, or BEINFT only when Green Operation Indicators (GOI) are greater than or equal to a governance threshold G0 and Energy-Normalized Metrics (ENM) are less than or equal to a governance threshold E0; (d) assembling an inseparable triplet comprising a transaction instruction, a BEISIGN statement, and minimum-disclosure proofs; and (e) processing the triplet through an exchange component, a clearing component, and a settlement component, each stage validating the triplet under Policy-VM constraints and, upon any validation failure or dispute, freezing affected parties and performing deterministic rollback under the READ control loop.

3. A non-transitory computer-readable medium storing instructions that, when executed by one or more processors, cause the processors to: (a) execute Charter-as-Code policies in a Policy-VM with BeiChart version pinning, activation timelocks, and rollback governance, the policies constraining validation at the exchange, clearing, and settlement components; (b) compute the BEI Index from identity-bound behavioral and temporal evidence and gate minting and settlement by GOI and ENM thresholds; (c) verify mutual consistency of DNSSEC and on-chain anchors for a personal subdomain before admitting state transitions; (d) enforce stage-wise validation of an inseparable triplet comprising an instruction, a BEISIGN consent, and proofs, with fail-closed freeze and deterministic rollback; and (e) maintain an append-only transparency log of BEISIGN statements, state transitions, and rollback artifacts.

4. The system of claim 1, wherein the consistency monitor maintains cached proof roots for the DNSSEC chain and the on-chain registry, compares root digests to detect drift, and upon drift detection automatically emits a dispute signal that triggers the READ control loop.

5. The system of claim 1, wherein the BEISIGN consent layer requires inclusion of the fields prev_commit, device_ref, counters, and a transparency-log locator to establish a causal chain, bind to a device, prevent replay, and enable audit retrieval.

6. The system of claim 1, wherein the BEISIGN consent layer supports multi-party threshold co-signature with a policy-defined quorum and requires an arbitrator co-signature for authority changes exceeding a value threshold.

7. The system of claim 1, wherein the transparency log is an append-only Merkle tree that supports targeted redaction by minimum-disclosure proofs while preserving auditability of the remaining tree.

8. The system of claim 1, wherein the READ control loop records causal history using vector clocks or conflict-free replicated data types (CRDTs), identifies a most recent causal-consistent checkpoint, and replays deterministic operations to restore consistency, and wherein idempotency keys prevent duplicate execution.

9. The system of claim 1, wherein a rollback artifact generated by the READ control loop includes actor identifiers, an intent summary, references to evidence, a human-readable rationale, and a checkpoint identifier.

10. The system of claim 1, wherein the inseparable triplet is validated at the exchange, clearing, and settlement components, each component performing schema canonicalization, signature verification, policy checks, and freshness checks, and wherein any failure causes pipeline halt, account freeze, and rollback under the READ control loop.

11. The system of claim 1, wherein the exchange component verifies message schema, supported signature suites, timestamp windows, device references, and policy guards before forwarding to clearing.

12. The system of claim 1, wherein the clearing component performs multi-leg netting across parties and corridors within time-bounded windows and places exceptions into a dead-letter queue for READ-managed resolution.

13. The system of claim 1, wherein the settlement component issues a proof-of-settlement receipt that is hash-bound to the BEISIGN statement and is posted to the transparency log.

14. The method of claim 2, wherein GOI and ENM are computed from device and infrastructure telemetry and wherein anti-gaming controls comprise rate limiting, anomaly detection, cross-source attestation, and revocation hooks, and wherein thresholds G0 and E0 are governed by BeiChart.

15. The method of claim 2, further comprising publishing the BEI Index through a zero-knowledge oracle with differential privacy and signature-protected messages that include nonces to prevent replay.

16. The system of claim 1, wherein offline proof bundles are encoded using COSE or CBOR with sequence numbers and replay thresholds, and online reconciliation merges the bundles into the transparency log while verifying sequence integrity.

17. The system of claim 1, wherein cryptographic keys are protected by trusted execution environments and threshold signatures with social recovery.

18. The medium of claim 3, wherein the Policy-VM enforces data residency and corridor rules by routing and storage guards that reject non-conforming operations at the exchange, clearing, and settlement components.

19. The system of claim 1, wherein the personal subdomain is allocated from a portfolio of at least 1,999 DNSSEC-governed root domains with uniform registry controls and anti-homograph allocation policies.

20. The system of claim 1, wherein the on-chain registry stores a record keyed by a namehash of the personal subdomain and comprising fields including a DID reference, an owner public key, a DNS proof root, and status flags selected from active, frozen, and revoked.
